(19) United States
(12) Patent Application Publication
(10) Pub. No.: US 2026/0313033 A1
(43) Pub. Date: Oct. 8, 2026

(54) DATA EXPORTING METHOD AND TERMINAL DEVICE

(71) Applicant: ARASHI VISION INC., Shenzhen (CN)

(72) Inventors: Dian DENG, Shenzhen (CN); Jingkang LIU, Shenzhen (CN)

(73) Assignee: ARASHI VISION INC., Shenzhen (CN)

(21) Appl. No.: 19/679,499

(22) Filed: May 15, 2026

Related U.S. Application Data
(63) Continuation of application No. PCT/CN2023/131982, filed on Nov. 16, 2023.

(51) Int. Cl. H04L 67/145; G06F 1/3209; H04L 67/06

(52) U.S. Cl. CPC H04L 67/145; G06F 1/3209; H04L 67/06

(57) ABSTRACT

The present disclosure relates to a data export method and a terminal apparatus. An application on the terminal apparatus maintains a communication connection with an imaging apparatus. Based on the communication connection, the data file stored in the imaging apparatus is exported through an application of the terminal apparatus. A predetermined keep-alive strategy is configured to maintain export of the data file through the application when the application runs in a background of the terminal apparatus. In the implementations of the present disclosure, when the application and the imaging apparatus maintain a communication connection, the task of exporting the data file in the imaging apparatus is started. When the application runs in a background of the terminal apparatus, a predetermined keep-alive strategy is adopted so that the application is not suspended by the operating system and continues to export the data file stored in the imaging apparatus. The application can continue exporting the data file from the imaging apparatus while running in the background, thereby satisfying a need for long-term and stable export of data file from the imaging apparatus when the application is running in the background.

### TECHNICAL FIELD

The present disclosure relates to the field of communication technology, and in particular, to a data export method and a terminal apparatus.

### BACKGROUND

An imaging apparatus contains a large number of data files such as pictures and videos. The imaging apparatus can be connected to a terminal apparatus, and an application on the terminal apparatus can be used to export the data files in the imaging apparatus to the terminal apparatus. However, this process takes a long time. Therefore, the user will put the application into the background of the terminal apparatus to export the data files in the imaging apparatus.

However, the operating system on the terminal apparatus will manage applications running in the background. Applications running in the background are often suspended by the operating system, causing the application to fail to run properly and thus unable to export the data files in the imaging apparatus.

### SUMMARY

In view of this, it is highly desirable to provide a data export method and a terminal apparatus that can keep the application alive so that the application can run normally in the background.

In a first aspect, the present disclosure provides a data export method, applied to a terminal apparatus, including:
maintaining a communication connection with an imaging apparatus;
based on the communication connection, exporting a data file in the imaging apparatus in an application of the terminal apparatus; and
using a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, establishing a Bluetooth communication connection with the imaging apparatus.

In one implementation, the keep-alive strategy further includes:
sending a heartbeat packet to the imaging apparatus based on the Bluetooth communication connection, so that the imaging apparatus remains in a power-on state and a communication connection enabled state.

In one implementation, the keep-alive strategy further includes: enabling Bluetooth scanning mode based on a preset time interval.

In one implementation, the keep-alive strategy further includes: sending location information.

In one implementation, the keep-alive strategy further includes: playing silent audio.

In one implementation, the keep-alive strategy is configured to enable the imaging apparatus to determine whether its state is in a data export state, and when the state of the imaging apparatus is in a data export state, to activate a keep-alive program within the imaging apparatus.

In one implementation, the method further includes:
when the application returns to the foreground of the terminal apparatus, disconnecting the Bluetooth communication connection.

In one implementation, the method further includes:
when the application enters the background of the terminal apparatus, displaying the export progress of the data file on the terminal apparatus; and/or
when the application enters the background of the terminal apparatus, synchronizing the export progress of the data file with the imaging apparatus based on the communication connection, so that the export progress of the data file is displayed on the imaging apparatus.

In a second aspect, the present disclosure further provides a data export device, applied to a terminal apparatus, including:
a connection module, configured to maintain a communication connection with an imaging apparatus;
a first export module, configured to export a data file in the imaging apparatus in an application of the terminal apparatus based on the communication connection; and
a second export module, configured to use a predetermined keep-alive strategy to maintain the export of the data file by the application when the application is running in the background of the terminal apparatus.

In a third aspect, the present disclosure further provides a terminal apparatus, including a memory, a communication component, and a processor. The memory stores a computer program. The communication component maintains a communication connection with an imaging apparatus.

The processor is configured to execute the computer program and, when executing the computer program, control the application of the terminal apparatus to export the data file in the imaging apparatus.

The processor uses a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, the processor controls the communication component to establish a Bluetooth communication connection with the imaging apparatus.

In one implementation, the keep-alive strategy further includes: the processor sends a heartbeat packet to the imaging apparatus based on the Bluetooth communication connection, so that the imaging apparatus remains in a power-on state and a communication connection enabled state.

In one implementation, the keep-alive strategy further includes: when the processor executes the application, enabling Bluetooth scanning mode based on a preset time interval.

In one implementation, the keep-alive strategy further includes: when the processor executes the application, sending location information.

In one implementation, the keep-alive strategy further includes: when the processor executes the application, playing silent audio.

In one implementation, the keep-alive strategy is configured to enable the imaging apparatus to determine whether its state is in a data export state, and when the state of the imaging apparatus is in a data export state, to activate a keep-alive program within the imaging apparatus.

In one implementation, when the application returns to the foreground of the terminal apparatus, the processor controls the communication component to disconnect the Bluetooth communication connection.

In one implementation, when the application enters the background of the terminal apparatus, displaying the export progress of the data file on the terminal apparatus; and/or when the application enters the background of the terminal apparatus, synchronizing the export progress of the data file with the imaging apparatus based on the communication connection, so that the export progress of the data file is displayed on the imaging apparatus.

In a fourth aspect, the present disclosure further provides a computer-readable storage medium, on which a computer program is stored. When the computer program is executed by a processor, the following operations are implemented:
maintaining a communication connection with an imaging apparatus;
based on the communication connection, exporting a data file in the imaging apparatus in an application of the terminal apparatus; and
using a predetermined keep-alive strategy to maintain the export of the data file by the application when the application is running in the background of the terminal apparatus.

In a fifth aspect, the present disclosure further provides a computer program product, including a computer program. When the computer program is executed by a processor, the following operations are implemented:
maintaining a communication connection with an imaging apparatus;
based on the communication connection, exporting a data file in the imaging apparatus in an application of the terminal apparatus; and
using a predetermined keep-alive strategy to maintain the export of the data file by the application when the application is running in the background of the terminal apparatus.

In the above data export method and terminal apparatus, an application on the terminal apparatus maintains a communication connection with an imaging apparatus. Based on the communication connection, the data file in the imaging apparatus is exported in the application of the terminal apparatus. A predetermined keep-alive strategy is used to maintain the export of the data file by the application when the application is running in the background of the terminal apparatus. In the implementations of the present disclosure, when the application and the imaging apparatus maintain a communication connection, the task of exporting the data file in the imaging apparatus is started. When the application is running in the background of the terminal apparatus, a predetermined keep-alive strategy is adopted so that the application is not suspended by the operating system and continues to export the data file in the imaging apparatus. Accordingly, the application can continue exporting the data file from the imaging apparatus while running in the background, thereby satisfying a need for long-term and stable export of data file from the imaging apparatus when the application is running in the background.

### BRIEF DESCRIPTION OF DRAWINGS

To illustrate the technical solutions in the implementations of the present disclosure or related technology, the drawings required for the description of the implementations or related technology are briefly introduced below. It is obvious that the drawings described below are only some implementations of the present disclosure. For those of ordinary skill in the art, other drawings can also be obtained based on these drawings without creative effort.

FIG. 1 is an application environment diagram of the data export method, according to some embodiments of the present disclosure.

FIG. 2 is a flowchart of the data export method, according to some embodiments of the present disclosure.

FIG. 3 is a flowchart of the data export method, according to some embodiments of the present disclosure.

FIG. 4 is a structural block diagram of the data export device, according to some embodiments of the present disclosure.

FIG. 5 is a schematic structural diagram of the terminal apparatus, according to some embodiments of the present disclosure.

### DETAILED DESCRIPTION

In order to make the objectives, technical solutions, and advantages of the present disclosure clearer, the following provides a further detailed description of the present disclosure in conjunction with the accompanying drawings and implementations. It should be understood that the specific implementations described herein are only for explaining the present disclosure and are not intended to limit the present disclosure.

In the related art, data export is performed by using the download interface provided by the operating system, and the download mode is set to background mode to export data files. However, the download interface provided by the operating system actually delegates the download task to the operating system process for management. The operating system manages the export task based on the overall operating condition of the terminal apparatus. Therefore, the export speed cannot be guaranteed, and the export task is susceptible to interruption or the application may be directly killed by the operating system.

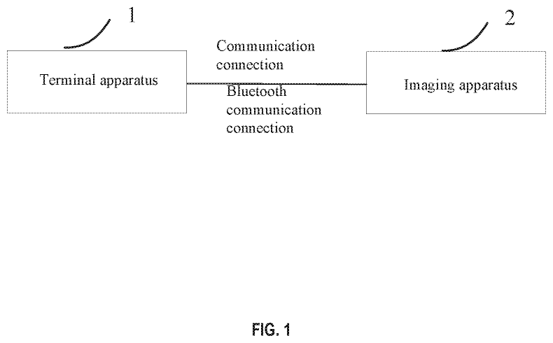

The data export method provided in the present disclosure can be applied in the application environment shown in FIG. 1. The application environment includes a terminal apparatus 1 and an imaging apparatus 2. When the terminal apparatus 1 and the imaging apparatus 2 establish a communication connection, the terminal apparatus 1 is configured to export data files in the imaging apparatus 2. The imaging apparatus 2 can be understood as an electronic device with photographing or video recording functions, such as an action camera, a gimbal with photographing or video recording functions, an Unmanned Aerial Vehicle (UAV) with photographing or video recording functions, and so on. The terminal apparatus 1 can include a mobile phone, a tablet computer, a desktop computer, a wearable device, a remote controller with processing functions, and so on.

When the imaging apparatus is an action camera, the action camera is compact and portable, and therefore is commonly used in sports scenarios. Due to the size requirements of the action camera, the battery capacity of the action camera is limited. Therefore, low power consumption control of the action camera is necessary. Existing action cameras are all set with a low power consumption mode. For example, when the user does not operate for a period of time, the camera will shut down or enter sleep mode. In existing action cameras, when the user exports videos or pictures and other data in the action camera through an application of the terminal apparatus, it is necessary to keep the application running in the foreground of the terminal apparatus to avoid the application being suspended in the background, which would otherwise cause data export failure. At the same time, data transmission and interaction can prevent the action camera from shutting down or entering sleep mode. However, for large file data export in such action cameras, the user needs to keep the application running in the foreground for a long time, which limits the user's other operations on the terminal apparatus. In addition, unexpected actions such as calls, alarms, or the phone screen turning off may cause the application to run in the background, resulting in export interruption and causing the action camera to be powered off or enter sleep mode. To address one or more problems mentioned above, the present disclosure provides a solution that includes sending a heartbeat packet from the terminal apparatus to the action camera so as to ensure the continuous operation of the action camera, without changing the low power consumption logic of the action camera. Moreover, when the operating system of the terminal apparatus is an iOS system, the application running in the background of the terminal apparatus is managed by the iOS system. Bluetooth communication connection can keep alive continuously and does not violate the rules of the iOS system, so there is no review risk.

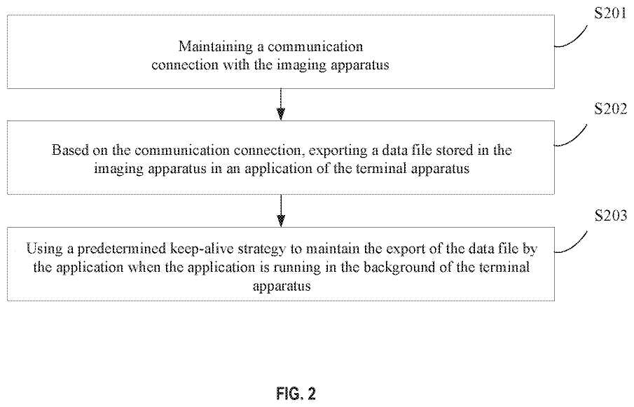

In an exemplary implementation, as shown in FIG. 2, a data export method is provided. The method is described below by taking an implementation as an example in which the method is applied to the terminal apparatus in FIG. 1. The method includes the following operations S201 to S203.

S201, maintaining a communication connection with the imaging apparatus.

In this implementation, the terminal apparatus maintains a communication connection with the imaging apparatus. The communication connection can be a Wi-Fi connection, a Bluetooth communication connection, a near field communication connection, and so on. The communication connection is used for data file transmission between the terminal apparatus and the imaging apparatus. Therefore, an appropriate communication connection method can be selected based on actual needs. For example, based on the requirement for export speed, the communication connection method can be selected as a Wi-Fi connection.

In one implementation, since the imaging apparatus is equipped with a network card, the application can obtain a specified Wi-Fi list by scanning the imaging apparatus. When connecting to the imaging apparatus, the interface NEHotspotConfigurationManager::apply(_ configuration: NEHotspotConfiguration) can be used to automatically connect to the corresponding Wi-Fi of the imaging apparatus.

S202, based on the communication connection, exporting a data file stored in the imaging apparatus through an application of the terminal apparatus.

In this implementation, the terminal apparatus receives an external operation instruction and, in response to the external operation instruction, uses the application to export the data file stored in the imaging apparatus. For example, exporting the data file includes backing up the data file stored in the imaging apparatus to the terminal apparatus, or migrating the data file stored in the imaging apparatus to the terminal apparatus.

S203, using a predetermined keep-alive strategy to maintain the export of the data file by the application when the application is running in the background of the terminal apparatus.

The keep-alive strategy can be, in the case when the application enters the background of the terminal apparatus, establishing a Bluetooth communication connection with the imaging apparatus. It can also be that the application enables Bluetooth scanning mode based on a preset time interval, or the terminal apparatus controls the application to send location information, play silent audio, and so on. For example, playing silent audio can avoid affecting the user's experience when the user uses other applications on the terminal apparatus.

In this implementation, after the application enters the background, the application remains active for a period of time, and then is suspended by the operating system and enters an inactive state. At this time, no operation can be performed. By using a predetermined keep-alive strategy, the application may not be suspended by the operating system when running in the background, so that the data file in the imaging apparatus can continue to be exported.

In one implementation, whether the application has entered the background can be determined by UIApplication. didEnterBackgroundNotification.

In the above-discussed data export method, the terminal apparatus maintains a communication connection with the imaging apparatus. Based on the maintained communication connection, the data file stored in the imaging apparatus is exported through an application of the terminal apparatus. A predetermined keep-alive strategy is used to maintain the export of the data file by the application when the application is running in the background of the terminal apparatus. In the present disclosure, when the application and the imaging apparatus maintain a communication connection, the task of exporting the data file in the imaging apparatus is started. When the application is running in the background of the terminal apparatus, a predetermined keep-alive strategy is adopted so that the application is not suspended by the operating system but continues to export the data file in the imaging apparatus. Accordingly, the application can continue exporting the data file from the imaging apparatus while running in the background, thereby satisfying a need for long-term and stable export of data file from the imaging apparatus when the application is running in the background.

In one implementation, when the application is in the foreground of the terminal apparatus, the communication connection between the terminal apparatus and the imaging apparatus for exporting the data file can be one of Wi-Fi connection, Bluetooth communication connection, near field communication connection, and so on. When the application is in the background of the terminal apparatus, the communication connection between the terminal apparatus and the imaging apparatus for exporting the data file can be another one of Wi-Fi connection, Bluetooth communication connection, near field communication connection, and so on, to balance power consumption and data export speed. For example, Wi-Fi connection has fast data export speed and high power consumption, while Bluetooth connection has slow data export speed and low power consumption. Different communication connection methods can be switched under the condition of maintaining the communication connection to form different power modes.

In one implementation, when the application is in the foreground and background of the terminal apparatus, the communication connection method between the terminal apparatus and the imaging apparatus for exporting the data file can be the same one of Wi-Fi connection, Bluetooth communication connection, near field communication connection, and so on. This allows the data export speed of the application in the background to be close to or the same as that when the application is running in the foreground. The user can estimate the completion time of data export after the application enters the background based on the data export speed in the foreground.

In one implementation, the keep-alive strategy further includes: sending a heartbeat packet to the imaging apparatus based on the Bluetooth communication connection, so that the imaging apparatus remains in a power-on state and a communication connection enabled state.

In this implementation, a heartbeat packet is continuously sent to the imaging apparatus based on the Bluetooth communication connection. The heartbeat packet indicates to the imaging apparatus that the application or the imaging apparatus itself is in a data export state, so that the imaging apparatus remains in a power-on state and a communication connection enabled state.

In one implementation, the Bluetooth of the imaging apparatus can be enabled when the imaging apparatus is powered on. When the processor on the terminal apparatus detects that the application enters the background of the terminal apparatus, the application calls the scanForPeripheralsWithServices interface to search for the imaging apparatus. After discovering the imaging apparatus, the application calls an interface: TelinkBluetoothManager::connectPeripheral:(CBPeripheral*)peripheral timeout: (NSTimeInterval)timeout resultBlock:(peripheralResultCallBack)block to establish a Bluetooth communication connection with the imaging apparatus.

In one implementation, after the application connects to the Bluetooth of the imaging apparatus, data can be written through the interface writeValue: (NSData *)value toPeripheral: (CBPeripheral *)peripheral. The data can be transmitted once per second to notify the imaging apparatus that it is in a data export state.

In one implementation, after receiving the heartbeat packet, the firmware in the imaging apparatus operates to keep the imaging apparatus in a power-on state and a communication connection enabled state.

In one implementation, the application sends a heartbeat packet to the imaging apparatus based on a preset time interval, so that the imaging apparatus remains in a power-on state and a communication connection enabled state. In one implementation, the time interval for sending the heartbeat packet to the imaging apparatus can be continuously adjusted based on the operating state of the application, so that the imaging apparatus remains in a power-on state and a communication connection enabled state.

In the present disclosure, a heartbeat packet is sent to the imaging apparatus via a Bluetooth communication connection, so that the imaging apparatus remains in a power-on state and a communication connection enabled state. The Bluetooth communication connection does not occupy additional performance resources of the operating system and does not conflict with audio playback on the terminal apparatus. Therefore, the solution is well suited for data file export by hardware-type applications, such as an imaging-apparatus-related application, which complies with the rules of the operating system, and reduces review risk.

In one implementation, the keep-alive strategy includes: enabling Bluetooth scanning mode based on a preset time interval; sending location information; or playing silent audio. In this case, the keep-alive strategy is used to enable the imaging apparatus to determine whether its state is in a data export state, and when the state of the imaging apparatus is in a data export state, to activate a keep-alive program within the imaging apparatus.

In this implementation, Bluetooth scanning mode is enabled based on a preset time interval, location messages are sent, or silent audio is played to prevent the application from being suspended by the operating system. At this time, there is no state interaction between the application and the imaging apparatus. That is, the terminal apparatus does not send a heartbeat packet to the imaging apparatus to notify the imaging apparatus whether the application is currently in a data export state. The imaging apparatus needs to determine whether its own state is in a data export state. When the state of the imaging apparatus is determined to be a data export state, a keep-alive program within the imaging apparatus is activated, so that the imaging apparatus remains in a power-on state and a communication connection state. The application can export the data file in the imaging apparatus based on the communication connection.

In one implementation, the data export method further includes: when the application returns to the foreground of the terminal apparatus, disconnecting the Bluetooth communication connection.

In this implementation, when the data file in the imaging apparatus is exported and the application returns to the foreground of the terminal apparatus, the Bluetooth communication connection is disconnected and the communication connection is terminated.

In one implementation, the data export method further includes: when the application enters the background of the terminal apparatus, displaying the export progress of the data file on the terminal apparatus; and/or, when the application enters the background of the terminal apparatus, synchronizing the export progress of the data file with the imaging apparatus based on the communication connection, so that the export progress of the data file is displayed on the imaging apparatus.

In one implementation, when the application returns to the foreground or the data export is completed, the interface TelinkBluetoothManager::cancelConnectionPeripheral:(CBPeripheral *)peripheral timeout:(NSTimeInterval)timeout resultBlock:(_Nullable peripheralResultCallBack)block can be called to disconnect the Bluetooth communication connection and terminate the Bluetooth communication.

In one implementation, whether the application has entered the foreground can be determined by listening to the system notification UIApplication.willEnterForegroundNotification.

In existing imaging apparatus, especially in existing action cameras, after the user shoots a video or multiple pictures, the video or pictures are highly desired to be exported to a terminal apparatus such as a mobile phone for viewing and confirming the angle, light illumination, etc., so as to quickly adjust for the next shooting. Such export process requires the user to know the download progress at any time, so that the user can adjust the scene, light illumination, and other time-related conditions during shooting. In the present disclosure, in one implementation, when the application enters the background of the terminal apparatus, a small floating window with a download progress bar is displayed in the foreground of the terminal apparatus, or the download progress percentage value is displayed on the top status bar of the terminal apparatus, making the download progress visible in the foreground. The user can observe the export status of the data file in real time. In one implementation, when the application enters the background of the terminal apparatus, the terminal apparatus synchronizes the export progress of the data file to the imaging apparatus based on the communication connection. The imaging apparatus displays the export progress of the data file visually through a progress bar, percentage value, and so on, thereby facilitating real-time observation of an export status of the data file by the user and improving the user experience.

For example, after the application connects to the Bluetooth of the imaging apparatus, data can be written through the interface writeValue: (NSData *)value toPeripheral:(CBPeripheral *)peripheral, and the specific stage of data export can be notified to the imaging apparatus once per second.

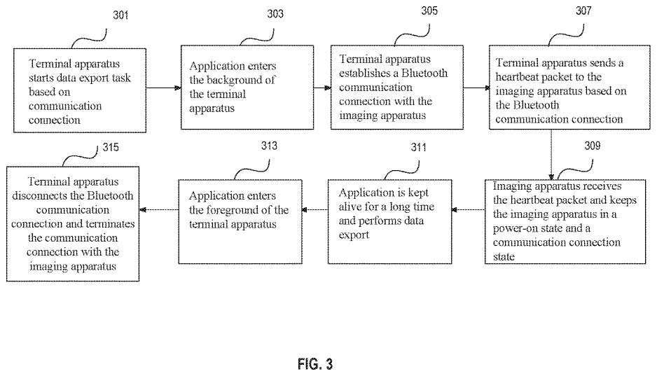

FIG. 3 is a flowchart of the data export method, according to some embodiments of the present disclosure. As shown in FIG. 3, the terminal apparatus establishes a communication connection with the imaging apparatus. Based on the communication connection, the data file export task is started. The application enters the background of the terminal apparatus, and the terminal apparatus establishes a Bluetooth communication connection with the imaging apparatus. A heartbeat packet is sent to the imaging apparatus based on the Bluetooth communication connection. The imaging apparatus receives the heartbeat packet sent by the terminal apparatus and keeps the imaging apparatus in a power-on state and a communication connection state. The application is kept alive for a long time and performs data export. The application enters the foreground of the terminal apparatus, and the terminal apparatus disconnects the Bluetooth communication connection and terminates the communication connection with the imaging apparatus.

It should be understood that although the operations in the flowcharts of the above implementations are shown sequentially according to the arrows, these operations are not necessarily executed in the order indicated by the arrows. Unless otherwise specified herein, the execution of these operations is not strictly limited in order, and these operations can be executed in other orders. Moreover, at least some of the operations in the flowcharts of the above implementations can include multiple operations or multiple stages. These operations or stages are not necessarily completed at the same time, but can be executed at different times. The execution order of these operations or stages is not necessarily sequential, but can be alternated or interleaved with at least part of other operations or operations in other stages.

The present disclosure also provides a data export device for implementing the above-mentioned data export method. The implementation solutions provided by the device are similar to those described in the above method. Therefore, the specific limitations in one or more implementations of the data export device provided below can refer to the limitations of the data export method described above and will not be repeated here.

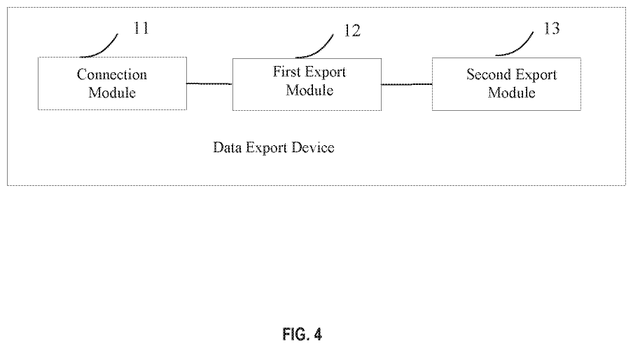

In an exemplary implementation, as shown in FIG. 4, a data export device is provided, including: a connection module 11, a first export module 12, and a second export module 13, where:
the connection module 11 is configured to maintain a communication connection with the imaging apparatus;
the first export module 12 is configured to export a data file in the imaging apparatus in an application of the terminal apparatus based on the communication connection; and
the second export module 13 is configured to adopt a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, establishing a Bluetooth communication connection with the imaging apparatus.

In one implementation, the keep-alive strategy further includes: sending a heartbeat packet to the imaging apparatus based on the Bluetooth communication connection, so that the imaging apparatus remains in a power-on state and a communication connection enabled state.

In one implementation, the keep-alive strategy further includes: enabling Bluetooth scanning mode based on a preset time interval.

In one implementation, the keep-alive strategy further includes: sending location information.

In one implementation, the keep-alive strategy further includes: playing silent audio.

In one implementation, the keep-alive strategy is configured to enable the imaging apparatus to determine whether its state is in a data export state, and when the state of the imaging apparatus is in a data export state, to activate a keep-alive program within the imaging apparatus.

In one implementation, the data export device further includes:
a disconnection module, configured to disconnect the Bluetooth communication connection if the application returns to the foreground of the terminal apparatus.

In one implementation, the data export device further includes:
a display module, configured to display the export progress of the data file on the terminal apparatus when the application enters the background of the terminal apparatus; and/or
a synchronization module, configured to synchronize the export progress of the data file to the imaging apparatus based on the communication connection when the application enters the background of the terminal apparatus, so that the export progress of the data file is displayed on the imaging apparatus.

Each module in the above data export device can be implemented by software, hardware, or a combination thereof. The above modules can be embedded in or independent of the processor in the terminal apparatus in hardware form, or can be stored in the memory of the terminal apparatus in software form, so that the processor can call and execute the operations corresponding to each module described above.

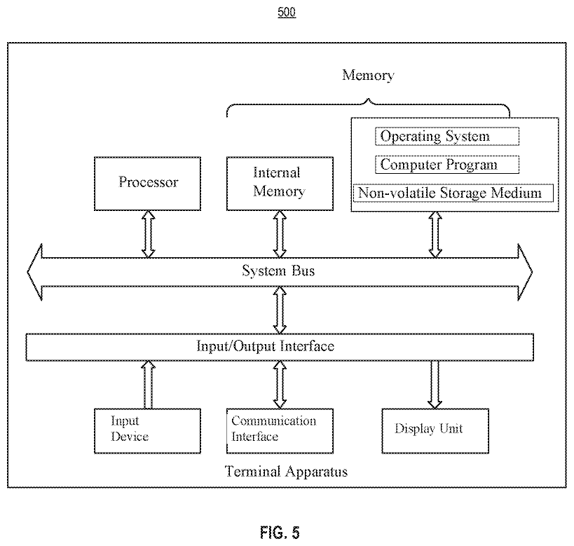

The present disclosure also provides a terminal apparatus. FIG. 5 illustrates an internal structure diagram, according to some embodiments of the present disclosure. As shown in FIG. 5, the terminal apparatus 500 includes a processor, a memory, an input/output interface, a communication interface, a display unit, and an input device. The processor, memory, and input/output interface are connected via a system bus. The communication interface, display unit, and input device are connected to the system bus via the input/output interface. The processor of the terminal apparatus is configured to provide computing and control capabilities. The memory of the terminal apparatus includes a non-volatile storage medium and an internal memory. The non-volatile storage medium stores the operating system and computer programs. The internal memory provides an environment for running the operating system and computer programs in the non-volatile storage medium. The input/output interface of the terminal apparatus is used for exchanging information between the processor and external devices. The communication interface of the terminal apparatus is used for wired or wireless communication with external terminals. The wireless method can be implemented by Wi-Fi, mobile cellular network, NFC (Near Field Communication), or other technologies. When the computer program is executed by the processor, a data export method is implemented. The display unit of the terminal apparatus is configured to form a visually visible picture, which can be a display screen, a projection device, or a virtual reality imaging device. The display screen can be a liquid crystal display or an electronic ink display. The input device of the terminal apparatus can be a touch layer covering the display screen, buttons, a trackball, or a touchpad set on the housing of the terminal apparatus 500, or an external keyboard, touchpad, or mouse, and so on.

Those skilled in the art can understand that the structure shown in FIG. 5 is only a block diagram of part of the structure related to the solution of the present disclosure and does not constitute a limitation on the terminal apparatus to which the solution of the present disclosure is applied. The specific terminal apparatus can include more or fewer components than those shown in the figure, or combine some components, or have different component arrangements.

In an exemplary implementation, a terminal apparatus is provided, including a memory and a processor. The memory stores a computer program, and the processor implements the following operations when executing the computer program:
maintaining a communication connection with the imaging apparatus;
based on the communication connection, exporting a data file in the imaging apparatus in an application of the terminal apparatus; and
using a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, establishing a Bluetooth communication connection with the imaging apparatus.

In one implementation, the keep-alive strategy further includes: sending a heartbeat packet to the imaging apparatus based on the Bluetooth communication connection, so that the imaging apparatus remains in a power-on state and a communication connection enabled state.

In one implementation, the keep-alive strategy further includes: enabling Bluetooth scanning mode based on a preset time interval.

In one implementation, the keep-alive strategy further includes: sending location information.

In one implementation, the keep-alive strategy further includes: playing silent audio.

In one implementation, the keep-alive strategy is used to enable the imaging apparatus to determine whether its state is in a data export state, and when the state of the imaging apparatus is in a data export state, to activate a keep-alive program within the imaging apparatus.

In one implementation, when the processor executes the computer program, the processor further implements the following operation:
when the application returns to the foreground of the terminal apparatus, disconnecting the Bluetooth communication connection.

In one implementation, when the processor executes the computer program, the processor further implements the following operations:
when the application enters the background of the terminal apparatus, displaying the export progress of the data file on the terminal apparatus; and/or
when the application enters the background of the terminal apparatus, synchronizing the export progress of the data file with the imaging apparatus based on the communication connection, so that the export progress of the data file is displayed on the imaging apparatus.

In one implementation, a computer-readable storage medium is provided, on which a computer program is stored. When the computer program is executed by a processor, the following operations are implemented:
maintaining a communication connection with the imaging apparatus;
based on the communication connection, exporting a data file in the imaging apparatus in an application of the terminal apparatus; and
using a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, establishing a Bluetooth communication connection with the imaging apparatus.

In one implementation, the keep-alive strategy further includes: sending a heartbeat packet to the imaging apparatus based on the Bluetooth communication connection, so that the imaging apparatus remains in a power-on state and a communication connection enabled state.

In one implementation, the keep-alive strategy further includes: enabling Bluetooth scanning mode based on a preset time interval.

In one implementation, the keep-alive strategy further includes: sending location information.

In one implementation, the keep-alive strategy further includes: playing silent audio.

In one implementation, the keep-alive strategy is configured to enable the imaging apparatus to determine whether the state of the imaging apparatus is in a data export state, and when the state of the imaging apparatus is in a data export state, the keep-alive strategy is configured to activate a keep-alive program within the imaging apparatus.

In one implementation, when the computer program is executed by the processor, the computer program further implements the following operation:
if the application returns to the foreground of the terminal apparatus, disconnecting the Bluetooth communication connection.

In one implementation, when the computer program is executed by the processor, the computer program further implements the following operations:
when the application enters the background of the terminal apparatus, displaying the export progress of the data file on the terminal apparatus; and/or
when the application enters the background of the terminal apparatus, synchronizing the export progress of the data file with the imaging apparatus based on the communication connection, so that the export progress of the data file is displayed on the imaging apparatus.

In one implementation, a computer program product is provided, including a computer program. When the computer program is executed by a processor, the following operations are implemented:
maintaining a communication connection with the imaging apparatus; based on the communication connection, exporting a data file in the imaging apparatus through an application of the terminal apparatus; and
using a predetermined keep-alive strategy to maintain the export of the data file by the application when the application is running in the background of the terminal apparatus.

In one implementation, the communication connection is a Wi-Fi connection.

In one implementation, the keep-alive strategy includes: when the application enters the background of the terminal apparatus, establishing a Bluetooth communication connection with the imaging apparatus.

In one implementation, the keep-alive strategy further includes: sending a heartbeat packet to the imaging apparatus based on the Bluetooth communication connection, so that the imaging apparatus remains in a power-on state and a communication connection enabled state.

In one implementation, the keep-alive strategy further includes: enabling Bluetooth scanning mode based on a preset time interval.

In one implementation, the keep-alive strategy further includes: sending location information.

In one implementation, the keep-alive strategy further includes: playing silent audio.

In one implementation, the keep-alive strategy is configured to enable the imaging apparatus to determine whether its state is in a data export state, and when the state of the imaging apparatus is determined to be in a data export state, the keep-alive strategy is configured to activate a keep-alive program within the imaging apparatus.

In one implementation, when the computer program is executed by the processor, the computer program further implements the following operation:
if the application returns to the foreground of the terminal apparatus, disconnecting the Bluetooth communication connection.

In one implementation, when the computer program is executed by the processor, the computer program further implements the following operations:
when the application enters the background of the terminal apparatus, displaying the export progress of the data file on the terminal apparatus; and/or
when the application enters the background of the terminal apparatus, synchronizing the export progress of the data file with the imaging apparatus based on the communication connection, so that the export progress of the data file is displayed on the imaging apparatus.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use, and processing of relevant data need to comply with relevant regulations.

Those of ordinary skill in the art can understand that all or part of the processes in the above implementations can be completed by instructing relevant hardware through a computer program. The computer program can be stored in a non-volatile computer-readable storage medium. When executed, the computer program can include the processes of the implementations of the methods described above. Any reference to memory, database, or other media used in the implementations of the present disclosure can include at least one of non-volatile and volatile memory. Non-volatile memory can include Read-Only Memory (ROM), magnetic tape, floppy disk, flash memory, optical storage, high-density embedded non-volatile memory, resistive random access memory (ReRAM), magnetoresistive random access memory (MRAM), ferroelectric random access memory (FRAM), phase change memory (PCM), graphene memory, and so on. Volatile memory can include Random Access Memory (RAM) or external high-speed cache, and so on. By way of illustration and not limitation, RAM can be in various forms, such as Static Random Access Memory (SRAM) or Dynamic Random Access Memory (DRAM), and so on. The database involved in the implementations of the present disclosure can include at least one of relational and non-relational databases. Non-relational databases can include blockchain-based distributed databases, and so on, without limitation. The processor involved in the implementations of the present disclosure can be a general-purpose processor, central processing unit, graphics processor, digital signal processor, programmable logic device, quantum computing-based data processing logic, and so on, without limitation.

The technical features of the above implementations can be combined arbitrarily. For the sake of brevity, not all possible combinations of the technical features in the above implementations are described. However, as long as there is no contradiction in the combination of these technical features, they should be regarded as within the scope described in this specification.

The above implementations only express several implementations of the present disclosure. The description is relatively specific and detailed, but should not be understood as limiting the scope of the present disclosure. It should be noted that, for those of ordinary skill in the art, several modifications and improvements can be made without departing from the concept of the present disclosure, and these all fall within the protection scope of the present disclosure. Therefore, the protection scope of the present disclosure should be subject to the appended claims.

What is claimed is:

1. A data export method, performed by a terminal apparatus, comprising:
establishing a first communication connection with an imaging apparatus;
based on the first communication connection, exporting a data file stored in the imaging apparatus through an application of the terminal apparatus; and
maintaining export of the data file through the application when the application runs in a background of the terminal apparatus, by using a predetermined keep-alive strategy;
wherein the keep-alive strategy comprises:
establishing a second communication connection with the imaging apparatus, the second communication connection being different from the first communication connection; and
sending a heartbeat packet to the imaging apparatus based on the second communication connection, to cause the imaging apparatus to remain in a power-on state and a communication connection enabled state.

2. The data export method according to claim 1, wherein the first communication connection is a Wi-Fi connection; and/or the second communication connection is a Bluetooth communication connection.

3. The data export method according to claim 1, wherein the imaging apparatus is in a low power consumption mode.

4. The data export method according to claim 3, wherein the low power consumption mode comprises: a mode in which the imaging apparatus turns off at least some functions without receiving a user operation within a preset time period.

5. The data export method according to claim 1, further comprising:
sending a heartbeat packet to the imaging apparatus based on a preset time interval; or
adjusting a time interval for sending the heartbeat packet to the imaging apparatus based on an operating state of the application.

6. The data export method according to claim 1, further comprising:
when the application is running in the background, maintaining the second communication connection.

7. The data export method according to claim 1, further comprising:
when the application is running in a foreground of the terminal apparatus, disconnecting the second communication connection.

8. The data export method according to claim 1, further comprising:
activating a keep-alive program within the imaging apparatus when the imaging apparatus is in a data export state.

9. The data export method according to claim 1, further comprising:
when the application is running in the background, displaying a small window on a foreground of the terminal apparatus or displaying an export progress of the data file on a top status bar.

10. The data export method according to claim 1, further comprising:
when the application is running in the background, synchronizing, by the terminal apparatus, an export progress of the data file with the imaging apparatus based on the first communication connection, wherein the export progress of the data file is displayed by the imaging apparatus.

11. A terminal apparatus, comprising a memory, a communication component, and a processor, wherein:
the memory stores a computer program;
the processor is configured to execute the computer program to control the communication component to establish a first communication connection with an imaging apparatus, an application of the terminal apparatus exports a data file stored in the imaging apparatus based on the first communication connection; and
the processor is configured to use a predetermined keep-alive strategy to maintain export of the data file through the application when the application is running in a background of the terminal apparatus,
wherein the keep-alive strategy comprises:
controlling the communication component to establish a second communication connection with the imaging apparatus, the second communication connection being different from the first communication connection; and
controlling the communication component to send a heartbeat packet to the imaging apparatus based on the second communication connection, to cause the imaging apparatus to remain in a power-on state and a communication connection enabled state.

12. The terminal apparatus according to claim 11, wherein the first communication connection is a Wi-Fi connection; and/or the second communication connection is a Bluetooth communication connection.

13. The terminal apparatus according to claim 11, wherein the imaging apparatus is in a low power consumption mode.

14. The terminal apparatus according to claim 13, wherein the low power consumption mode comprises: a mode in which the imaging apparatus turns off at least some functions without receiving a user operation within a preset time period.

15. The terminal apparatus according to claim 11, wherein the processor is further configured to:
control the communication component to send a heartbeat packet to the imaging apparatus based on a preset time interval; or
adjust a time interval for the communication component to send the heartbeat packet to the imaging apparatus based on an operating state of the application.

16. The terminal apparatus according to claim 11, wherein when the application is running in the background, the processor controls the communication component to maintain the second communication connection.

17. The terminal apparatus according to claim 11, wherein when the application is running in a foreground of the terminal apparatus, the processor controls the communication component to disconnect the second communication connection.

18. The terminal apparatus according to claim 11, wherein the processor is further configured to:
activate a keep-alive program within the imaging apparatus when the imaging apparatus is in a data export state.

19. The terminal apparatus according to claim 11, further comprising a display module, wherein the processor is further configured to:
when the application is running in the background, control the display module to display a small window on a foreground of the terminal apparatus or display an export progress of the data file on a top status bar.

20. The terminal apparatus according to claim 11, further comprising a synchronization module, wherein the processor is configured to:
when the application is running in the background, control the synchronization module to synchronize an export progress of the data file with the imaging apparatus based on the first communication connection, for the imaging apparatus to display the export progress of the data file.
